(19) United States
(12) Patent Application Publication
(10) Pub. No.: US 2024/0361242 A1
(43) Pub. Date: Oct. 31, 2024

(54) MEASUREMENT UNIT, METHOD FOR MANUFACTURING MEASUREMENT UNIT, AND BIOLOGICAL SAMPLE MEASUREMENT METHOD

(71) Applicant: HAMAMATSU PHOTONICS K.K., Hamamatsu-shi (JP)

(72) Inventor: Kimiko KAZUMURA, Hamamatsu-shi (JP)

(73) Assignee: HAMAMATSU PHOTONICS K.K., Hamamatsu-shi (JP)

(21) Appl. No.: 18/641,606

(22) Filed: Apr. 22, 2024

(30) Foreign Application Priority Data
Apr. 28, 2023 (JP) 2023-074638
Jan. 25, 2024 (JP) 2024-009568

(51) Int. Cl. G01N 21/64; G01N 21/17

(52) U.S. Cl. CPC G01N 21/6428; G01N 21/1717; G01N 2021/1731

(57) ABSTRACT

A measurement unit is a measurement unit used for measuring a characteristic of a biological sample. The measurement unit includes a first container that includes a first housing space, a first opening communicating with the first housing space, and a light transmission region through which light generated in the first housing space is transmitted, and a first solution that is a mixture of a plurality of reagents containing an indicator reacting with a component generated from the biological sample. The first solution is housed in the first housing space in a state of being frozen.

### TECHNICAL FIELD

The present disclosure relates to a measurement unit, a method for manufacturing a measurement unit, and a biological sample measurement method.

### BACKGROUND

Japanese Unexamined Patent Publication No. 2019-213464 describes a technique for measuring a characteristic of a biological sample. In the technique described in Japanese Unexamined Patent Publication No. 2019-213464, the characteristic of the biological sample may be measured by adding a biological sample collected from a subject (for example, human body) to a preparation solution produced by introducing a plurality of reagents into a container and then measuring light generated in a housing space of the container.

### SUMMARY

In the technique described above, at least one of the plurality of reagents may be likely to deteriorate in a state of a room temperature, and in this case, it is desirable to perform operations such as the production of the preparation solution and the introduction of the preparation solution into the container immediately before the optical measurement and near the subject. However, when these operations are performed near the subject, there is a concern that the operations are complicated.

An object of the present disclosure is to provide a measurement unit, a method for manufacturing a measurement unit, and a biological sample measurement method capable of maintaining quality of a preparation solution and simple operations.

A measurement unit of the present disclosure is a “measurement unit used for measuring a characteristic of a biological sample, and including a first container that includes a first housing space, a first opening communicating with the first housing space, and a light transmission region through which light generated in the first housing space is transmitted, and a first solution that is a mixture of a plurality of reagents containing an indicator reacting with a component generated from the biological sample, in which the first solution is housed in the first housing space in a state of being frozen.”.

### BRIEF DESCRIPTION OF THE DRAWINGS

FIG. 1 is a front view of a measurement unit according to an embodiment;

FIG. 2 is a front view of a first measurement kit illustrated in FIG. 1;

FIG. 3 is a sectional view taken along line III-III of FIG. 2;

FIG. 4 is a sectional view taken along line IV-IV of FIG. 3;

FIG. 5 is a sectional view taken along line V-V of FIG. 4;

FIG. 6 is a partial sectional view of a second measurement kit illustrated in FIG. 1;

FIG. 7 is a diagram illustrating steps of a method for manufacturing a measurement unit illustrated in FIG. 1;

FIG. 8 is a schematic diagram of a measurement device;

FIG. 9 is a schematic diagram of the measurement device;

FIG. 10 is a diagram illustrating steps of a biological sample measurement method using the measurement unit illustrated in FIG. 1;

FIG. 11 is a diagram illustrating a modification of the first measurement kit; and

FIG. 12 is a sectional view taken along line II-II of FIG. 11.

### DETAILED DESCRIPTION

Hereinafter, an embodiment of the present disclosure will be described in detail with reference to the drawings. Note that, the same or corresponding parts in the respective drawings are denoted with the same reference signs, and repetitive descriptions will be omitted.

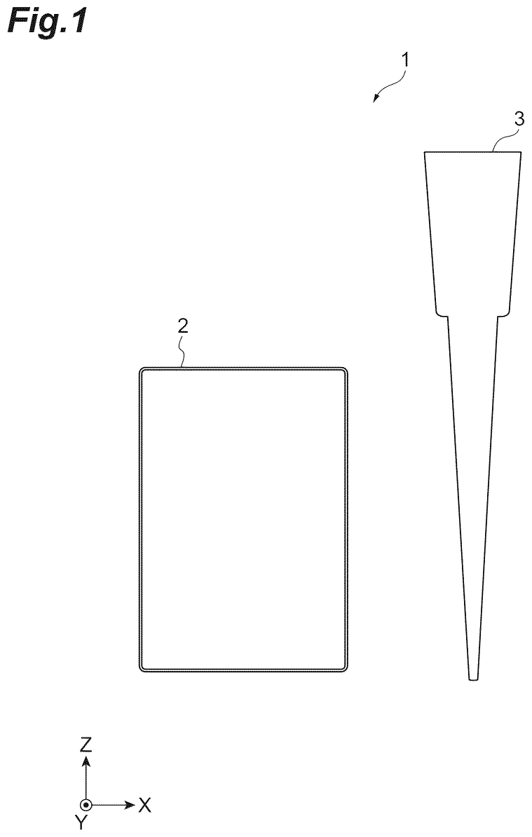

A measurement unit 1 illustrated in FIG. 1 is used for measuring a characteristic of a biological sample. The biological sample is, for example, blood (for example, whole blood) of a subject (living body) or the like. The subject is, for example, a human body or the like. In the present embodiment, the subject is a patient in a hospital. The biological sample contains, for example, white blood cells. The characteristic of the biological sample is, for example, an activity of the white blood cell. In the present embodiment, the characteristic of the biological sample is an activity of a neutrophil.

The neutrophil cell is a type of white blood cell. A main role of the neutrophil cell is to prevent infection by phagocytosing and sterilizing bacteria and fungi that have invaded the living body. The neutrophil cell takes up bacteria and the like into a neutrophil by wrapping the bacteria and the like with a neutrophilic plasma membrane. As a result, a food vacuole is formed. When the food vacuole fuses with a granule, granule contents are released into the food vacuole. ROS (reactive oxygen species) (superoxide or hydrogen peroxide) is generated by NADPH oxidase formed in a cell membrane (membrane of food vacuole), and this ROS sterilizes bacteria and the like. In addition, hypochlorous acid (HOCl) (or halogen equivalents thereof) is produced from hydrogen peroxide (H₂O₂) and chlorine ion (CI⁻) by an enzymatic reaction of myeloperoxidase (EC number 1.11.2.2) contained in the granule content, and the hypochlorous acid sterilizes bacteria and the like. Accordingly, a myeloperoxidase activity or a superoxide production activity is used as an index for evaluating the activity of the neutrophil cell. The measurement unit 1 of the present embodiment is used for measuring the myeloperoxidase activity or the superoxide production activity.

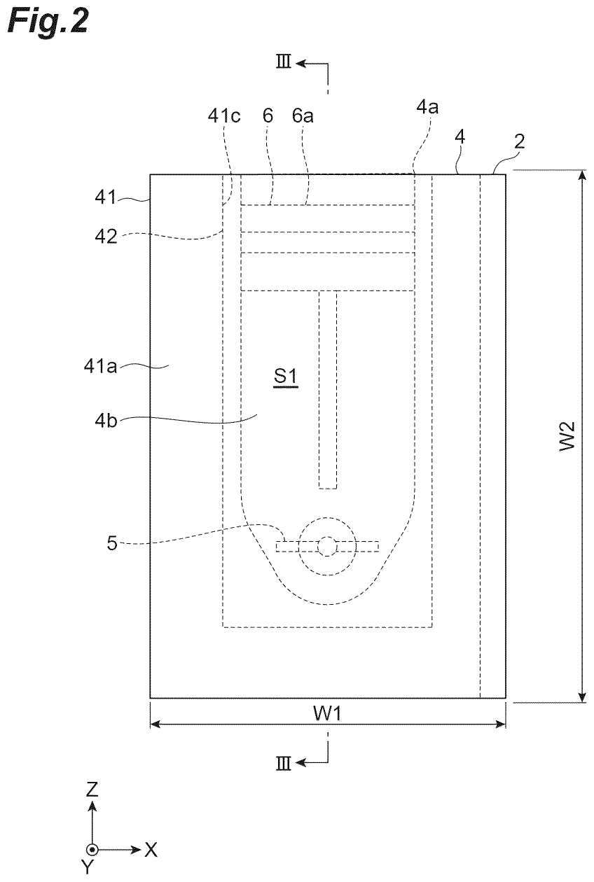

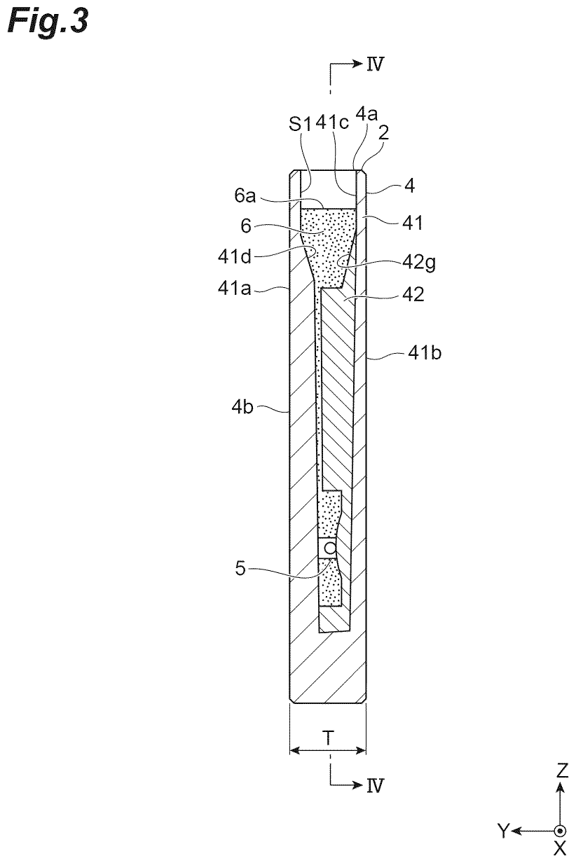

As illustrated in FIG. 1, the measurement unit 1 includes a first measurement kit 2 and a second measurement kit 3. As illustrated in FIGS. 2 and 3, the first measurement kit 2 includes a first container 4, a rotor 5, and a first solution 6. The first container 4 includes a first housing space S1 and an opening (first opening) 4a. The opening 4a communicates with the first housing space S1. The first container 4 has, for example, a flat plate shape. The first container 4 has, for example, a rectangular plate shape.

A thickness T of the first container 4 (a length of the first container 4 in a Y-axis direction) is smaller than a width W1 of the first container 4 (a length of the first container 4 in an X-axis direction). The thickness T of the first container 4 is ⅓ or less of the width W1 of the first container 4. The thickness T of the first container 4 is smaller than a height W2 of the first container 4 (a length of the first container 4 in a Z-axis direction). The thickness T of the first container 4 is ⅓ or less of the height W2 of the first container 4. The height W2 of the first container 4 is larger than the width W1 of the first container 4. The height W2 of the first container 4 is 1.1 times or more the width W1 of the first container 4. The thickness T of the first container 4 is, for example, about 6 mm. The width W1 of the first container 4 is, for example, about 28 mm. The height W2 of the first container 4 is, for example, about 41 mm.

The first container 4 includes a first member 41 and a second member 42. The first member 41 has, for example, a rectangular plate shape. The first member 41 includes principal surfaces 41a and 41b and a housing space 41c. The principal surface 41a and the principal surface 41b face opposite sides in the Y-axis direction (thickness direction of the first container 4). The housing space 41c opens at one end of the first member 41 in the Z-axis direction (height direction of the first container 4). The housing space 41c reaches one end of the first member 41 in the Z-axis direction and does not reach the other end of the first member 41 in the Z-axis direction. The housing space 41c has, for example, a rectangular shape as viewed in the Y-axis direction.

The first member 41 includes a recess 41d. The recess 41d is formed on a surface of an inner surface of the housing space 41c facing a side opposite to the principal surface 41a. The recess 41d is open at one end of the first member 41 in the Z-axis direction. A depth of the recess 41d gradually increases from the other end side of the first member 41 in the Z-axis direction toward one end side of the first member 41 in the Z-axis direction, and then is maintained at a constant value. A width of the recess 41d in the X-axis direction is smaller than a maximum width of the housing space 41c in the X-axis direction. Both ends of the recess 41d in the X-axis direction are positioned inside both ends of the housing space 41c in the X-axis direction.

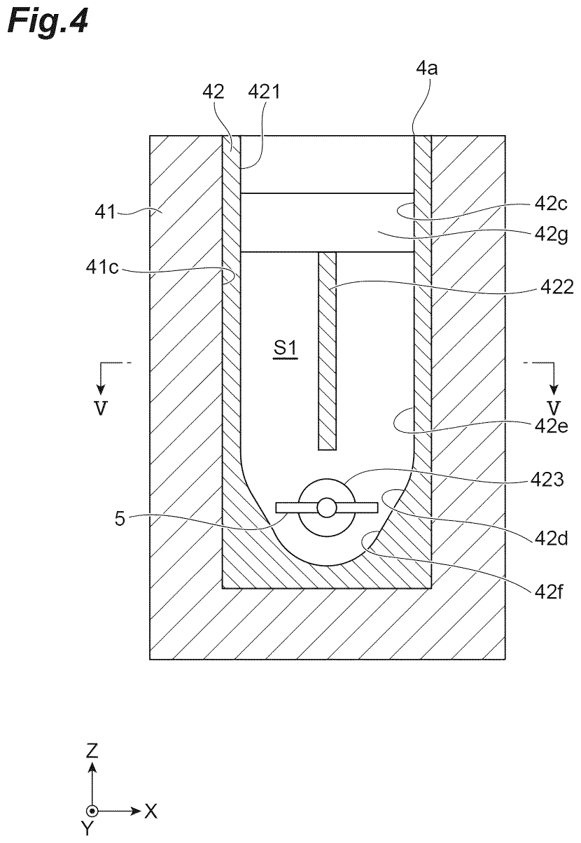

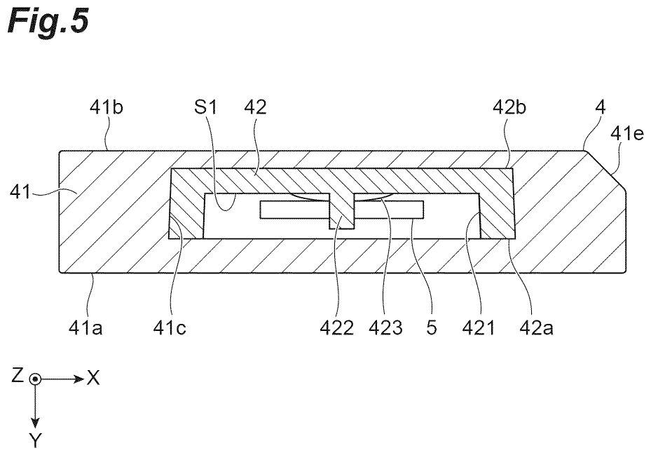

The second member 42 is disposed in the housing space 41c of the first member 41. As illustrated in FIGS. 4 and 5, the second member 42 has, for example, a rectangular plate shape. An outer shape of the second member 42 substantially coincides with a shape of the housing space 41c. Specifically, a width of the second member 42 in the X-axis direction is the same as a width of the housing space 41c in the X-axis direction. A width of the second member 42 in the Y-axis direction is the same as a width of the housing space 41c in the Y-axis direction. A width of the second member 42 in the Z-axis direction is the same as a width of the housing space 41c in the Z-axis direction.

The second member 42 includes principal surfaces 42a and 42b, a recess 421, a partition wall 422, and a support 423. The principal surface 42a and the principal surface 42b face opposite sides in the Y-axis direction. The principal surface 42a faces the same side as the principal surface 41a of the first member 41. The principal surface 42a is in contact with the inner surface of the housing space 41c. The principal surface 42b faces the same side as the principal surface 41b of the first member 41. The principal surface 42b is in contact with the inner surface of the housing space 41c. The recess 421 is formed in the principal surface 42a. The recess 421 reaches one end of the second member 42 in the Z-axis direction and does not reach the other end of the second member 42 in the Z-axis direction.

The partition wall 422 protrudes from a bottom surface of the recess 421. A height (width in the Y-axis direction) of the partition wall 422 is smaller than a depth of the recess 421. A top surface of the partition wall 422 is positioned between the principal surface 42a and the principal surface 42b. The partition wall 422 extends along the Z-axis direction as viewed in the Y-axis direction. Both ends of the partition wall 422 in the Z-axis direction are positioned inside both ends of the recess 421 in the Z-axis direction. The partition wall 422 is a partial region of the second member 42.

The recess 421 includes a first region 42c, a second region 42d, and an intermediate region 42e. The first region 42c is positioned on one side in the Z axis direction with respect to the partition wall 422. The first region 42c has, for example, a rectangular shape as viewed in the Y-axis direction. The first region 42c is open at one end of the second member 42 in the Z-axis direction. The second region 42d is positioned on the other side in the Z axis direction with respect to the partition wall 422. As viewed in the Y-axis direction, a width of the second region 42d in the X-axis direction gradually decreases from one end side of the second member 42 in the Z-axis direction toward the other end side of the second member 42 in the Z-axis direction. That is, the recess 421 includes an inner surface 42f having a curved surface shape. The inner surface 42f is curved toward a side opposite to the partition wall 422 as viewed in the Y-axis direction.

The intermediate region 42e is positioned between the first region 42c and the second region 42d. The intermediate region 42e communicates with the first region 42c and the second region 42d. The intermediate region 42e has, for example, a rectangular shape as viewed in the Y-axis direction. As viewed in the Y-axis direction, a position of one end of the intermediate region 42e in the Z-axis direction coincides with a position of one end of the partition wall 422 in the Z-axis direction, and a position of the other end of the intermediate region 42e in the Z-axis direction coincides with a position of the other end of the partition wall 422 in the Z-axis direction.

The support 423 is positioned in the second region 42d. The support 423 protrudes from the bottom surface of the recess 421. A surface of the support 423 has, for example, a curved surface shape. The support 423 is a partial region of the second member 42.

The second member 42 includes an inclined region 42g (see also FIG. 3). The inclined region 42g is parallel to the X-axis direction and is inclined with respect to an XZ plane. The inclined region 42g is formed in a region on one side in the Z axis direction with respect to the partition wall 422 on the bottom surface of the recess 421. The inclined region 42g is inclined to approach the principal surface 42b toward the opening 4a. One end of the inclined region 42g in the Z-axis direction reaches the principal surface 42b. One end of the inclined region 42g in the Z axis direction is positioned inside the opening 4a. The other end of the inclined region 42g in the Z axis direction coincides with the position of one end of the partition wall 422 in the Z axis direction. A width of the inclined region 42g in the X-axis direction is the same as a width of the recess 421 in the X-axis direction.

The first housing space S1 is a space excluding the second member 42 in the housing space 41c. The opening 4a of the first container 4 is formed by an opening of the housing space 41c and an opening of the recess 421. The first container 4 includes a light transmission region 4b. The light transmission region 4b is a region of the first member 41 overlapping the first housing space SI (recess 421) as viewed in the Y-axis direction. The light transmission region 4b is a portion of the first member 41 on a side opposite to the principal surface 41b with respect to the first housing space S1. Light generated in the first housing space S1 passes through the light transmission region 4b. In the present embodiment, the entire first member 41 and second member 42 are light-transmissive. A material of each of the first member 41 and the second member 42 is, for example, a transparent resin or the like.

An identification surface 41e is formed on the principal surface 41b of the first member 41. The identification surface 41e is parallel to the Z-axis direction and is inclined with respect to the principal surface 41b. The identification surface 41e reaches both ends of the first member 41 in the Z-axis direction. According to the identification surface 41e, the principal surface 41a including the light transmission region 4b can be easily identified. The first member 41 is integrally made of the same material. As a result, leakage of the first solution 6 housed in the housing space 41c is suppressed.

The rotor 5 is disposed in the second region 42d. The rotor 5 has, for example, a rod shape. The rotor 5 has, for example, magnetism. A diameter of the rotor 5 is, for example, 1 mm or less, and a length of the rotor 5 is, for example, 10 mm or less. The rotor 5 includes, for example, a core material, a plating layer formed on a surface of the core material, and the like. The core material has, for example, magnetism. A material of the plating layer is, for example, gold or the like. The rotor 5 rotates in accordance with rotation of a rotation device provided outside the first container 4. The rotor 5 rotates about a line parallel to the Y-axis direction in a state of being supported by the support 423.

The first solution 6 is housed in the first housing space S1. The first solution 6 fills a part of the first region 42c. The first solution 6 fills the intermediate region 42e and the second region 42d. A surface 6a of the first solution 6 is positioned between one end of the partition wall 422 and the opening 4a in the Z-axis direction. That is, the first solution 6 does not reach the opening 4a. The rotor 5 is immersed in the first solution 6. In other words, the rotor 5 is housed in the first housing space S1 to be immersed in the first solution 6. The rotor 5 is buried in the first solution 6. Note that, in FIGS. 4 and 5, the illustration of the first solution 6 is omitted.

The first solution 6 is a mixture of a plurality of reagents. For example, the first solution 6 contains, as the plurality of reagents, physiological saline, a buffer solution, a fluorescent indicator, and the like. The fluorescent indicator reacts with a component (HOCl) generated from the biological sample. The fluorescent indicator is, for example, aminophenyl fluorescein (APF) or the like. A commercially available product may be used as the fluorescent indicator.

The first solution 6 is frozen in a state of being housed in the first housing space S1. The first solution 6 may be entirely frozen or partially frozen. A temperature of the first solution 6 is equal to or lower than a freezing point of any reagent contained in the first solution 6. That is, the temperature of the first solution 6 may be the same as the freezing point of any reagent contained in the first solution 6, or may be lower than the freezing point of any reagent contained in the first solution 6. In the present embodiment, the temperature of the first solution 6 is equal to or lower than a freezing point of a reagent having a largest volume among the plurality of reagents contained in the first solution 6. The temperature of the first solution 6 may be equal to or lower than a freezing point of a reagent having a lowest freezing point among the plurality of reagents contained in the first solution 6. In the present embodiment, the temperature of the first solution 6 is equal to or lower than a freezing point of the buffer solution contained in the first solution 6. The temperature of the first solution 6 may be equal to or lower than the freezing point of the fluorescent indicator contained in the first solution 6. In the present embodiment, the entire temperature of the first measurement kit 2 is equal to or lower than the freezing point of any reagent contained in the first solution 6. The temperature of the first solution 6 is, for example, about −20° C. Note that, in the present embodiment, the “temperature” refers to a temperature under an atmospheric pressure.

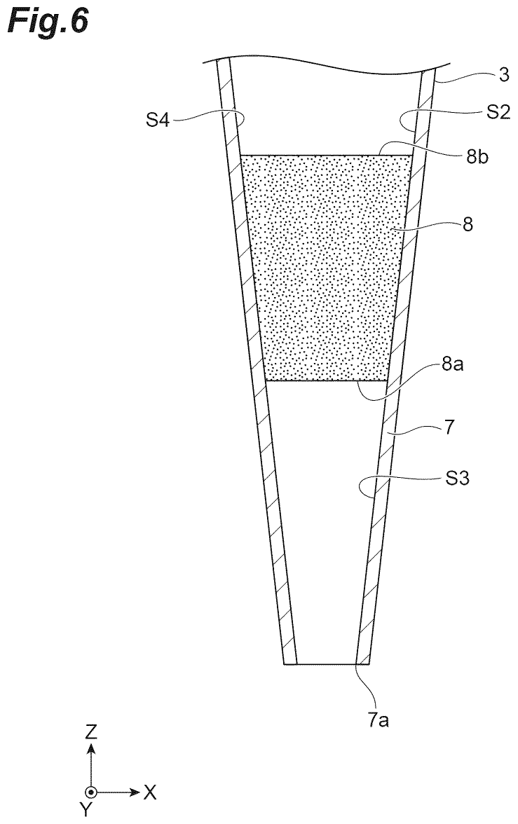

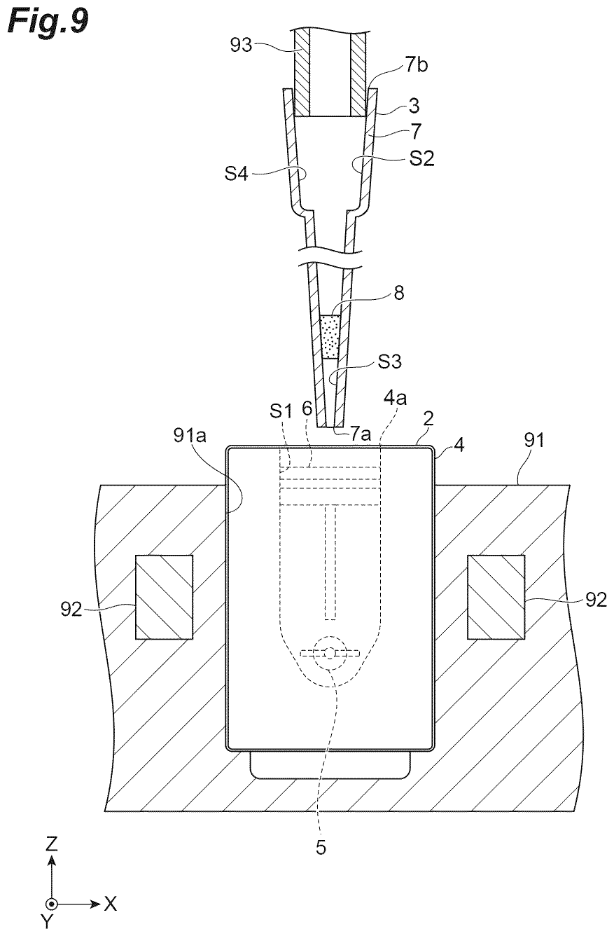

As illustrated in FIG. 6, the second measurement kit 3 includes a second container 7 and a second solution 8. The second container 7 has, for example, a conical shape of which a center line is a line parallel to the Z-axis direction. The second container 7 has, for example, elasticity. The second container 7 includes a second housing space S2, an opening (second opening) 7a, and an opening (third opening) 7b (see FIG. 9). The opening 7a and the opening 7b face opposite sides. The opening 7a and the opening 7b communicate with the second housing space S2. The second housing space S2 has, for example, a conical shape. A sectional area of the second housing space S2 decreases from the opening 7b toward the opening 7a. A diameter of the opening 7a is smaller than a diameter of the opening 7b. The opening 7a is a discharge port of the second container 7. The opening 7a may function as a suction port of the second container 7. The second container 7 is, for example, a pipette tip or the like.

The second solution 8 is housed in the second housing space S2. The second solution 8 fills a part of the second housing space S2. A temporary housing space S3 is present between the second solution 8 and the opening 7a, and a space S4 is present between the second solution 8 and the opening 7b. Specifically, the second solution 8 is positioned inside each of the opening 7a and the opening 7b. The second solution 8 includes a surface 8a facing the opening 7a and a surface 8b facing the opening 7b. The surface 8a is separated from the opening 7a. The surface 8b is separated from the opening 7b.

A volume of the temporary housing space S3 is equal to or larger than a volume of the second solution 8. A length of the temporary housing space S3 in the Z-axis direction (distance between the opening 7a and the surface 8a) is equal to or longer than a length of the second solution 8 in the Z-axis direction (distance between the surface 8a and the surface 8b). A volume of the space S4 is equal to or larger than the volume of the second solution 8. A length of the space S4 in the Z-axis direction (distance between the opening 7b and the surface 8b) is equal to or longer than the length of the second solution 8 in the Z-axis direction. The volume of the space S4 may be smaller than the volume of the second solution 8. The length of the space S4 in the Z-axis direction may be smaller than the length of the second solution 8 in the Z-axis direction. The volume of the space S4 is equal to or larger than the volume of the temporary housing space S3. The length of the space S4 in the Z-axis direction is equal to or longer than the length of the temporary housing space S3 in the Z-axis direction. The volume of the space S4 may be smaller than the volume of the temporary housing space S3. The length of the space S4 in the Z-axis direction may be smaller than the length of the temporary housing space S3 in the Z-axis direction.

The second solution 8 is a mixture of a plurality of reagents. For example, the second solution 8 contains, as the plurality of reagents, a stimulant, an organic solvent, a buffer solution (buffer), and the like. The stimulant is a reagent for activating a function of the biological sample. The stimulant stimulates, for example, the neutrophil cell of the biological sample in a pseudo manner. When the neutrophil cell is stimulated in the pseudo manner, an innate immune reaction (defense mechanism) of the neutrophil cell is initiated. The stimulant is, for example, N-formyl-L-methionyl-L-leucyl-phenylalanine (fMLP), 4β-phorbol-12-myristate-13-acetate (PMA), or the like. The organic solvent is a reagent for dissolving a stimulant in a powder state. The organic solvent is, for example, dimethyl sulfoxide (DMSO) or the like. The buffer solution is a reagent for diluting an organic solvent. Since the organic solvent is diluted with the buffer solution in the second solution 8, even though the second solution 8 is directly applied to the biological sample, damage of the biological sample by the organic solvent is suppressed. A commercially available product may be used as each of the stimulant, the organic solvent, and the buffer solution, for example.

The second solution 8 is frozen in a state of being housed in the second housing space S2. The second solution 8 is frozen in a state where the temporary housing space S3 is present between the second solution 8 and the opening 7a and the space S4 is present between the second solution 8 and the opening 7b. The second solution 8 may be entirely frozen or partially frozen. A temperature of the second solution 8 is equal to or lower than a freezing point of any reagent contained in the second solution 8. That is, the temperature of the second solution 8 may be the same as the freezing point of any reagent contained in the second solution 8, or may be lower than the freezing point of any reagent contained in the second solution 8. In the present embodiment, the temperature of the second solution 8 is equal to or lower than a freezing point of a reagent having a largest volume among the plurality of reagents contained in the second solution 8. The temperature of the second solution 8 may be equal to or lower than a freezing point of a reagent having a lowest freezing point among the plurality of reagents contained in the second solution 8. In the present embodiment, the temperature of the second solution 8 is equal to or lower than a freezing point of the buffer solution contained in the second solution 8. In the present embodiment, the entire temperature of the second measurement kit 3 is equal to or lower than the freezing point of any reagent contained in the second solution 8. The temperature of the second solution 8 is lower than the temperature of the first solution 6. The temperature of the second solution 8 is, for example, −40° C. or lower. In the present embodiment, the temperature of the second solution 8 is −80° C. When the organic solvent is diluted with the buffer solution, the stimulant dissolved in the organic solvent may easily deteriorate. In the present embodiment, since the temperature of the second solution 8 is lower than the temperature of the first solution 6 as described above (since the temperature of the second solution is extremely low temperature), even though the organic solvent is diluted with the buffer solution in order to directly apply the second solution 8 to the biological sample, it is possible to store the second solution 8 while maintaining a state where the deterioration of the stimulant dissolved in the organic solvent is suppressed.

As described above, in the measurement unit 1, the first solution 6 which is the mixture of the plurality of reagents is housed in the first housing space S1 in a state of being frozen. As a result, the measurement unit 1 can be carried near the subject in a state where the first solution 6 is frozen, and the biological sample collected from the subject can be added to the first solution 6 after the first solution 6 is defrosted near the subject. Thus, not only quality of the first solution 6 is maintained, but also operations such as production of the first solution 6 and introduction of the first solution 6 into the first container 4 are unnecessary near the subject. Accordingly, according to the measurement unit 1, the quality of the first solution 6 is maintained, and an operation for measuring the characteristic of the biological sample is simplified.

The biological sample contains a white blood cell. A solution used for measuring the characteristic of the white blood cell may require cryopreservation. As described above, since the first solution 6 is frozen, the cryopreservation of the first solution 6 is realized.

The indicator is a fluorescent indicator. A solution containing the fluorescent indicator may require cryopreservation. As described above, since the first solution 6 containing the fluorescent indicator is frozen, the cryopreservation of the first solution 6 containing the fluorescent indicator is realized.

The measurement unit 1 includes the rotor 5 housed in the first housing space S1 to be immersed in the first solution 6. As a result, the defrosted first solution 6 and the biological sample added to the first housing space S1 can be stirred by the rotor 5, and dispersion of the biological sample in the first solution 6 can be promoted. In addition, the stirring of the rotor 5 can promote transfer of heat in the first solution 6, and defrosting efficiency of the first solution 6 in a defrosting step of the first solution 6 can be enhanced.

The first container 4 has a flat plate shape. As a result, for example, since a specific surface area of the first container 4 is increased as compared with a case where the container has a columnar shape, the defrosting efficiency of the first solution 6 is improved.

The thickness T of the first container 4 is ⅓ or less of the width W1 of the first container 4. As a result, since transfer efficiency of heat to the first housing space S1 is improved, the defrosting efficiency of the first solution 6 is improved.

The height W2 of the first container 4 is 1.1 times or more the width W1 of the first container 4. As a result, the volume of the first housing space S1 is secured, and the defrosting efficiency of the first solution 6 is improved.

The first container 4 includes the inner surface 42f having the curved surface shape. As a result, since a liquid housed in the first housing space S1 easily flows, the dispersion of the biological sample in the first solution 6 is promoted.

The measurement unit 1 includes the second container 7 and the second solution 8. The second container 7 includes the second housing space S2 and the opening 7a communicating with the second housing space S2. The second solution 8 contains a stimulant for activating the function of the biological sample. The second solution 8 is housed in the second housing space S2 in a state of being frozen. As a result, the measurement unit 1 can be carried to near the subject in a state where the second solution 8 is frozen, and after the second solution 8 is defrosted near the subject, the defrosted second solution 8 can be added to the first solution 6. Thus, not only quality of the second solution 8 is maintained, but also operations such as production of the second solution 8 and introduction of the second solution 8 into the second container 7 are unnecessary near the subject. Accordingly, the quality of the second solution 8 is maintained, and an operation for measuring the characteristic of the biological sample is simplified.

The temporary housing space S3 is present between the second solution 8 and the opening 7a. As a result, even though a part of the defrosted second solution 8 moves toward the opening 7a, since a part of the second solution 8 is housed in the temporary housing space S3, leakage of the second solution 8 from the opening 7a is suppressed. For example, in a case where the position of the surface of the solution coincides with the position of the opening, when the solution is defrosted, there is a concern that a part of the defrosted solution drips from the opening. In the present embodiment, as described above, the leakage of the second solution 8 from the opening 7a is suppressed.

A volume of the temporary housing space S3 is equal to or larger than a volume of the second solution 8. As a result, the leakage of the second solution 8 from the opening 7a is reliably suppressed.

The second container 7 is a pipette tip. Accordingly, acquisition of the second container 7 is facilitated.

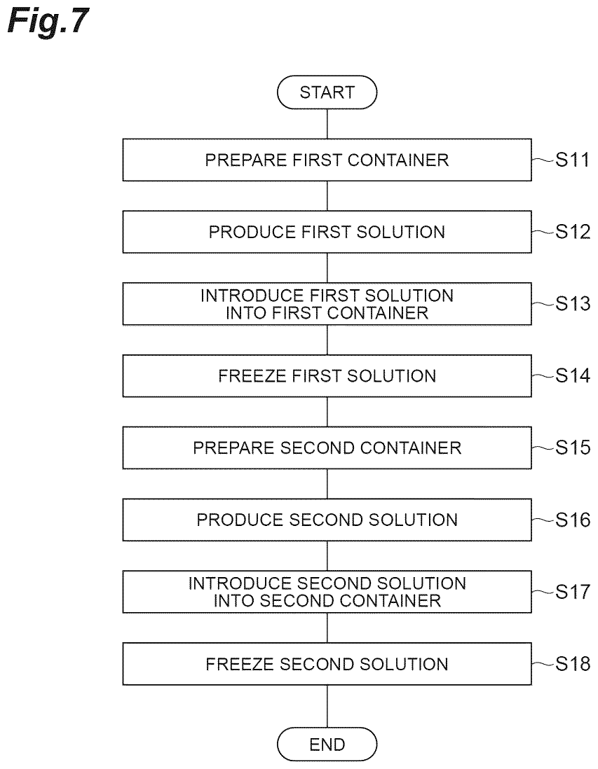

Next, a method for manufacturing the measurement unit 1 will be described. As illustrated in FIG. 7, first, in step S11, the first container 4 is prepared. Step S11 corresponds to a first preparation step. In step S11, the first container 4 is prepared in a state where the rotor 5 is housed in the first housing space S1.

Subsequently, in step S12, the first solution 6 is produced. Step S12 corresponds to a solution production step. In step S12, the plurality of reagents (physiological saline, buffer solution, fluorescent indicator, and the like) are mixed outside the first housing space S1. The volume of the first solution 6 produced in step S12 is several times or more the volume of the first housing space S1. That is, in step S12, a larger amount of the first solution 6 than the volume of the first housing space S1 is produced. Subsequently, in step S13, the first solution 6 produced in advance is introduced into the first housing space S1. In step S13, the first solution 6 is sequentially introduced into the first housing spaces SI of the plurality of first containers 4.

Subsequently, in step S14, the first solution 6 is frozen in a state of being housed in the first housing space S1. Step S14 corresponds to a first freezing step. In step S14, the first solution 6 is frozen in a state where the rotor 5 housed in the first housing space S1 is immersed in the first solution 6. In step S14, the first container 4 housing the rotor 5 and the first solution 6 is disposed in a cooling space of a cooling facility. A temperature of the cooling space is, for example, about −20° C. The first container 4 is disposed in the cooling space for about two hours, for example. As a result, the first solution 6 is frozen, and the first measurement kit 2 is manufactured. The first measurement kit 2 may be stored in the cooling space. In step S14, the opening 4a of the first container 4 may be sealed with a sealing member such as parafilm or a rubber stopper.

Subsequently, in step S15, the second container 7 is prepared. Step S15 corresponds to a second preparation step. Subsequently, in step S16, the second solution 8 is produced. In step S16, the plurality of reagents (stimulant, organic solvent, buffer solution, and the like) are mixed outside the second housing space S2. The volume of the second solution 8 produced in step S16 is several times or more the volume of the second housing space S2. That is, in step S16, a larger amount of the second solution 8 than the volume of the second housing space S2 is produced.

Subsequently, in step S17, the second solution 8 produced in advance is introduced into the second housing space S2. Step S17 corresponds to a solution introduction step. In step S17, after the second solution 8 is sucked into the second housing space S2 via the opening 7a, air is further sucked into the second housing space S2 via the opening 7a.

Specifically, in step S17, a prescribed amount of the second solution 8 is disposed in a preliminary container such as a microtube or a microplate. Subsequently, a suction nozzle is inserted into the opening 7b of the second container 7. Subsequently, the second container 7 is disposed such that the opening 7a of the second container 7 comes into contact with the second solution 8. Subsequently, the prescribed amount of the second solution 8 is sucked into the second housing space S2 via the opening 7a by a suction force of the suction nozzle. Subsequently, air is sucked into the second housing space S2 via the opening 7a. As a result, the temporary housing space S3 is formed between the opening 7a and the second solution 8. A volume of the air sucked in step S17 is equal to or larger than a volume of the second solution 8 sucked in step S17. Note that, in step S17, for example, the second solution 8 disposed in one preliminary container or the like may be simultaneously introduced into the second housing spaces S2 of the plurality of second containers 7.

Subsequently, in step S18, the second solution 8 is frozen in a state of being housed in the second housing space S2. Step S18 corresponds to a second freezing step. In step S18, the suction nozzle is pulled out from the opening 7b of the second container 7. Subsequently, the second container 7 is disposed in the cooling space of the cooling facility in a state where the temporary housing space S3 is present between the opening 7a and the second solution 8 and the space S4 is present between the opening 7b and the second solution 8. The temperature of the cooling space is, for example, about −80° C. The second container 7 is disposed in the cooling space for about one hour, for example. As a result, the second solution 8 is frozen, and the second measurement kit 3 is manufactured. The second measurement kit 3 may be stored in the cooling space. One first measurement kit 2 and one second measurement kit 3 may be stored in the same cooling space in a state of being housed in one package. Note that, at least one of step S15 to step S18 may be performed simultaneously with at least one of step S11 to step S14.

As described above, according to this manufacturing method, the measurement unit 1 having the above-described effect can be manufactured.

In step S12, the plurality of reagents are mixed outside the first housing space S1. As a result, the first solution 6 produced outside the first housing space S1 can be sequentially introduced into the first housing spaces S1 of the plurality of first containers 4, and manufacturing efficiency of the measurement unit 1 can be improved.

In step S14, the first solution 6 is frozen in a state where the rotor 5 housed in the first housing space S1 is immersed in the first solution 6. As a result, the measurement unit 1 having the rotor 5 immersed in the first solution 6 can be manufactured.

In step S18, the second solution 8 is frozen in a state where the temporary housing space S3 is present between the second solution 8 and the opening 7a. As a result, even though a part of the second solution 8 moves toward the opening 7a in step S18, since a part of the second solution 8 is housed in the temporary housing space S3, the leakage of the second solution 8 from the opening 7a is suppressed.

In step S17, after the second solution 8 is sucked into the second housing space S2 via the opening 7a, air is further sucked into the second housing space S2 via the opening 7a. As a result, the temporary housing space S3 can be formed between the second solution 8 and the opening 7a. In addition, the prescribed amount of the second solution 8 can be accurately sucked into the second housing space S2.

A volume of the air sucked in step S17 is equal to or larger than a volume of the second solution 8 sucked in step S17. As a result, the leakage of the second solution 8 from the opening 7a is reliably suppressed.

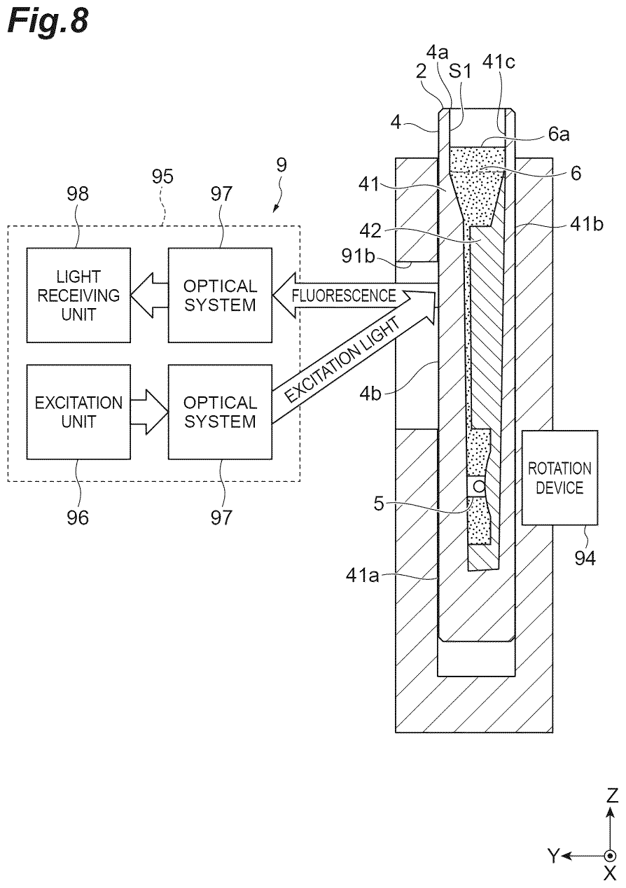

Next, a biological sample measurement method using the measurement unit 1 will be described. First, a measurement device will be described. As illustrated in FIGS. 8 and 9, the measurement device 9 includes a support member 91, heaters 92, a nozzle 93, a rotation device 94, and an optical device 95. The support member 91 includes an attachment space (slot) 91a and an opening 91b. The opening 91b penetrates a side wall of the support member 91. The opening 91b communicates with the attachment space 91a. The first measurement kit 2 is attached to the attachment space 91a such that the light transmission region 4b faces the opening 91b. The heaters 92 are provided on the side wall of the support member 91. The heaters 92 are provided on both sides in the X-axis direction with respect to the attachment space 91a as viewed in the Y-axis direction. The heat generated from the heater 92 is transferred to the first measurement kit 2 via the support member 91.

The nozzle 93 is disposed above the support member 91 in a vertical direction. The nozzle 93 discharges, for example, air. The opening 7b of the second container 7 is attached to the nozzle 93. When air is discharged from the nozzle 93, a pressure in the space S4 becomes larger than a pressure in the temporary housing space S3. The defrosted second solution 8 is led out from the opening 7a by a pressure difference between the space S4 and the temporary housing space S3. The second solution 8 led out from the opening 7a is added to the first housing space S1 of the first container 4.

The rotation device 94 is disposed on a side opposite to the opening 91b with respect to the attachment space 91a. The rotation device 94 is, for example, a magnetic stirrer. The rotation device 94 rotates the rotor 5 of the first measurement kit 2.

The optical device 95 is disposed on a side opposite to the rotation device 94 with respect to the attachment space 91a. The optical device 95 includes an excitation unit 96, optical systems 97, and a light receiving unit 98. The excitation unit 96 includes, for example, a light emitting element such as a laser diode or a light emitting diode. The excitation unit 96 emits excitation light. The optical systems 97 are disposed between the excitation unit 96 and the attachment space 91a and between the light receiving unit 98 and the attachment space 91a. The optical system 97 is, for example, a lens that collects light. The light receiving unit 98 includes, for example, a photoelectric conversion element such as a photodiode. The light receiving unit 98 detects incident light. The excitation light emitted from the excitation unit 96 reaches the first housing space S1 via the optical systems 97, the opening 91b, and the light transmission region 4b. As a result, a substance generated by a reaction between a component generated from the biological sample and the fluorescent indicator of the first solution 6 is excited, and as a result, fluorescence is generated. The fluorescence reaches the light receiving unit 98 via the light transmission region 4b, the opening 91b, and the optical systems 97. The light receiving unit 98 detects the fluorescence.

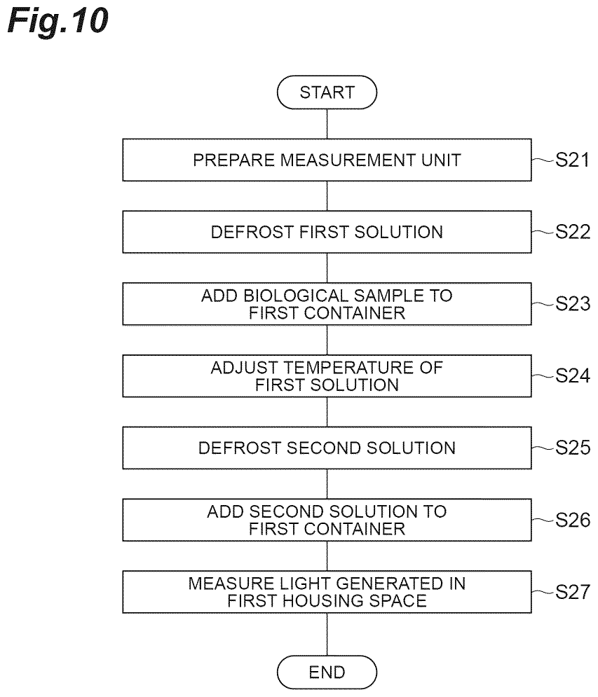

As illustrated in FIG. 10, in the biological sample measurement method, first, in step S21, the measurement unit 1 is prepared. Step S21 corresponds to a preparation step.

Subsequently, in step S22, the first solution 6 is defrosted. Step S22 corresponds to a first defrosting step. In step S22, the first measurement kit 2 is attached to the attachment space 91a. In step S22, the first solution 6 is heated by the heater 92 until the first solution is defrosted. The heat of the heater 92 is transferred to the first solution 6 via the support member 91 and the first container 4. In step S22, the first solution 6 is continuously heated such that the temperature of the first solution 6 reaches an appropriate temperature (optimum temperature) for the biological sample. The appropriate temperature for the biological sample is, for example, 37° C. In step S22, the first solution 6 is heated such that the temperature of the first solution 6 is, for example, 36.5° C. to 37.5° C. In step S22, the first solution 6 is heated for, for example, 5 minutes to 10 minutes. As a result, since the first solution 6 is heated relatively gently, deterioration in function of the first solution 6 is suppressed.

In step S22, the first solution 6 is heated while the rotor 5 is rotated. Specifically, in step S22, the rotor 5 is rotated after the first solution 6 becomes flowable as a result of being defrosted. When the rotor 5 rotates, the first solution 6 sequentially flows through the first region 42c, one side of the intermediate region 42e, the second region 42d, and the other side of the intermediate region 42e, and flows from the other side of the intermediate region 42e to one side of the intermediate region 42e through a region between the partition wall 422 and an inner surface of the first member 41. As a result, the heat transfer in the first solution 6 is promoted, and the defrosting efficiency of the first solution 6 is improved. In step S22, the rotation device 94 may be started before the first solution 6 becomes flowable (for example, before the first measurement kit 2 is attached to the attachment space 91a). In this case, the rotor 5 rotates at the same time as the first solution 6 becomes flowable. Subsequently, in step S23, the biological sample is added to the first housing space S1 via the opening 4a. Step S23 corresponds to a first adding step. In step S23, a small amount (about 2 μL to 3 μL) of a peripheral blood collected from a finger of the subject by a blood collection tool such as a lancet is added as the biological sample to the first housing space S1.

Subsequently, in step S24, the temperature of the first solution 6 is adjusted. Step S24 corresponds to a temperature adjustment step. In step S24, the first solution 6 is heated by the heater 92. In step S24, the first solution 6 is heated such that the temperature of the first solution 6 is maintained at the appropriate temperature for the biological sample. In step S24, the first solution 6 is heated such that the temperature of the first solution 6 is, for example, 36.8° C. to 37.2° C. In step S24, the first solution 6 is heated while the rotor 5 is rotated. Step S24 continues to be performed until the biological sample measurement method is completed.

Subsequently, in step S25, the second solution 8 is defrosted. Step S25 corresponds to a second defrosting step. In step S25, the second measurement kit 3 is left for 1 to 2 minutes in a state where the second container 7 of the second measurement kit 3 is attached to the nozzle 93. That is, in step S25, the second solution 8 is naturally defrosted. Since the temporary housing space S3 is present between the second solution 8 and the opening 7a, even though a part of the defrosted second solution 8 moves toward the opening 7a, a part of the second solution 8 is housed in the temporary housing space S3. While the second solution 8 is defrosted, the air present in the space S4 expands due to a temperature rise of the air present in the space S4. When the air present in the space S4 expands, the defrosted second solution 8 moves toward the opening 7a and the volume of the temporary housing space S3 decreases. However, the temporary housing space S3 is still present between the second solution 8 and the opening 7a after the movement. In a state where the defrosting of the second solution 8 is completed, the defrosted second solution 8 may reach the opening 7a. That is, in a state where the defrosting of the second solution 8 is completed, there may be no space between the second solution 8 and the opening 7a. Step S25 may be performed simultaneously with at least one of step S22 to step S24.

Subsequently, in step S26, the defrosted second solution 8 is led out from the opening 7a and is added to the first housing space S1 via the opening 4a. Step S26 corresponds to a second adding step. In step S26, a content from a predetermined position on a side opposite to the opening 7a with respect to the second solution 8 in the second housing space S2 to the opening 7a are led out from the opening 7a. The predetermined position is a position between the surface 8b of the second solution 8 and the opening 7b. That is, the predetermined position is separated from the surface 8b of the second solution 8. In step S26, a content having a volume larger than a sum of the volume of the defrosted second solution 8 and the volume of the temporary housing space S3 is led out from the opening 7a. In step S26, air is discharged from the nozzle 93. The volume of the discharged air is larger than the sum of the volume of the defrosted second solution 8 and the volume of the temporary housing space S3. As a result, the second solution 8 and the content positioned closer to the opening 7a than the second solution 8 are reliably led out from the opening 7a. Note that, in step S26, the second solution 8 may be added to the first housing space S1 in a state where the temperature of the second solution 8 is maintained at an appropriate temperature (optimum temperature) for the stimulant.

Subsequently, in step S27, the light generated in the first housing space S1 and transmitted through the light transmission region 4b of the first container 4 is measured. Step S27 corresponds to a measurement step. In step S27, the excitation light is continuously emitted to the first housing space S1, and the light generated in the first housing space S1 is continuously detected. Irradiation of the excitation light and detection of the light start before step S26. That is, the irradiation of the excitation light and the detection of the light start before the addition of the second solution 8 to the first container 4.

When the first housing space S1 in which the reaction between the fluorescent indicator of the first solution 6 and the HOCl generated from the biological sample is in progress is irradiated with excitation light having a wavelength of about 480 nm, fluorescence having a wavelength of about 515 nm is generated in the first housing space S1. In step S27, fluorescence having a wavelength of about 515 nm is detected. As a result, the myeloperoxidase activity is measured.

As described above, in the biological sample measurement method of the present embodiment, the first solution 6 that is the mixture of the plurality of reagents is prepared in a state of being housed and frozen in the first housing space S1 of the first container 4. As a result, the measurement unit 1 can be carried near the subject in a state where the first solution 6 is frozen, and the biological sample collected from the subject can be added to the first solution 6 after the first solution 6 is defrosted near the subject. Thus, not only quality of the first solution 6 is maintained, but also operations such as production of the first solution 6 and introduction of the first solution 6 into the first container 4 are unnecessary near the subject. In addition, in the biological sample measurement method of the present embodiment, the second solution 8 is prepared in a state of being housed and frozen in the second housing space S2 of the second container 7. As a result, the measurement unit 1 can be carried to near the subject in a state where the second solution 8 is frozen, and after the second solution 8 is defrosted near the subject, the defrosted second solution 8 can be added to the first solution 6. Thus, not only quality of the second solution 8 is maintained, but also operations such as production of the second solution 8 and introduction of the second solution 8 into the second container 7 are unnecessary near the subject. As described above, according to the biological sample measurement method of the present embodiment, the qualities of the first solution 6 and the second solution 8 are maintained, and the operation for measuring the characteristic of the biological sample is simplified.

In step S22, the first solution 6 is continuously heated such that the temperature of the first solution 6 reaches the appropriate temperature for the biological sample, and in step S24, the first solution 6 is heated such that the temperature of the first solution 6 is maintained at the appropriate temperature for the biological sample. As a result, the first solution 6 is defrosted, and a suitable temperature environment for the biological sample is maintained.

In step S21, the rotor 5 immersed in the first solution 6 is prepared, and in step S24, the first solution 6 is heated while the rotor 5 is rotated. As a result, temperature adjustment of the first solution 6 and dispersion of the biological sample in the first solution 6 are promoted. In addition, in step S22, since the first solution 6 is defrosted while the rotor 5 is rotated, the defrosting efficiency of the first solution 6 is improved.

In step S26, a content from a predetermined position on a side opposite to the opening 7a with respect to the second solution 8 in the second housing space S2 to the opening 7a are led out from the opening 7a. As a result, all of the second solution 8 housed in the second housing space S2 is reliably led out from the opening 7a.

Although the embodiment of the present disclosure has been described above, the present disclosure is not limited to the above-described embodiment.

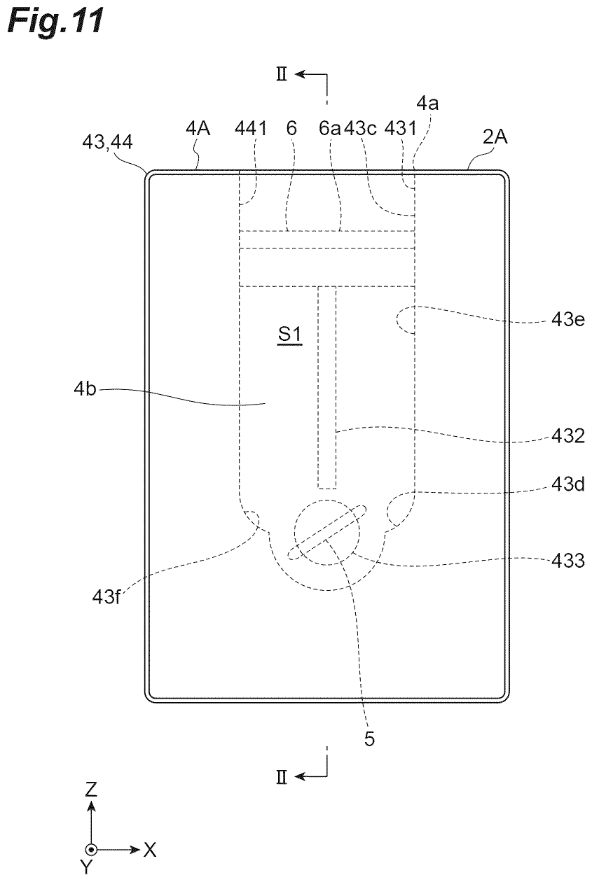

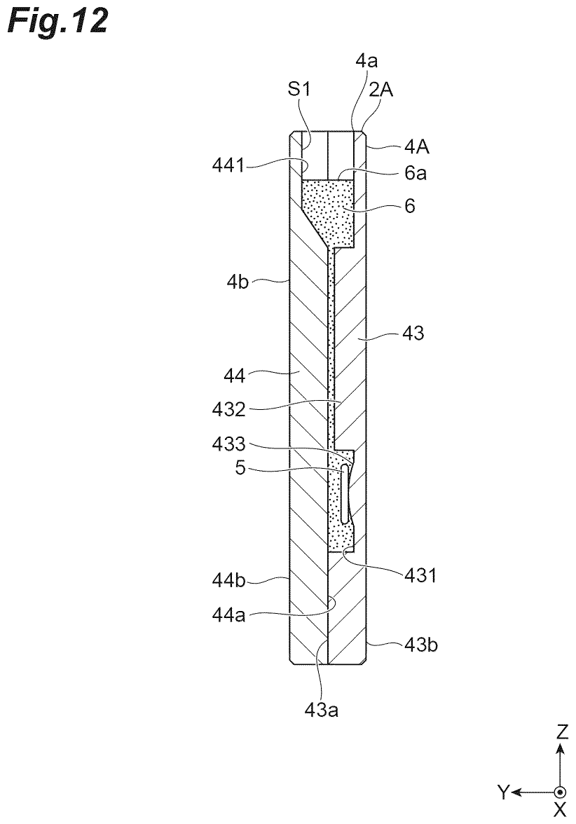

As illustrated in FIGS. 11 and 12, the measurement unit 1 may include a first measurement kit 2A instead of the first measurement kit 2. The first measurement kit 2A is mainly different from the first measurement kit 2 in that the first measurement kit 2A includes a first container 4A instead of the first container 4.

The first container 4A includes a first plate member 43 and a second plate member 44. The first plate member 43 has, for example, a rectangular plate shape. The first plate member 43 includes principal surfaces 43a and 43b, a recess 431, a partition wall 432, and a support 433. The principal surface 43a and the principal surface 43b face opposite sides in the Y-axis direction (thickness direction of the first container 4A). The recess 431 is formed in the principal surface 43a. The recess 431 extends along the Z-axis direction (height direction of the first container 4A) as viewed in the Y-axis direction. The recess 431 reaches one end of the first plate member 43 in the Z-axis direction and does not reach the other end of the first plate member 43 in the Z-axis direction.

The partition wall 432 protrudes from a bottom surface of the recess 431. A height (width in the Y-axis direction) of the partition wall 432 is smaller than a depth of the recess 431. A top surface of the partition wall 432 is positioned between the principal surface 43a and the principal surface 43b. The partition wall 432 extends along the Z-axis direction as viewed in the Y-axis direction. Both ends of the partition wall 432 in the Z-axis direction are positioned inside both ends of the recess 431 in the Z-axis direction. The partition wall 432 is a partial region of the first plate member 43.

The recess 431 includes a first region 43c, a second region 43d, and an intermediate region 43e. The first region 43c is positioned on one side in the Z-axis direction with respect to the partition wall 432. The first region 43c has, for example, a rectangular shape as viewed in the Y-axis direction. The first region 43c is open at one end of the first plate member 43 in the Z-axis direction. The second region 43d is positioned on the other side in the Z axis direction with respect to the partition wall 432. As viewed in the Y-axis direction, a width of the second region 43d in the X-axis direction (width direction of the first container 4A) gradually decreases from one end side of the first plate member 43 in the Z-axis direction toward the other end side of the first plate member 43 in the Z-axis direction. That is, the recess 431 includes an inner surface 43f having a curved surface shape. The inner surface 43f is curved toward a side opposite to the partition wall 432 as viewed in the Y-axis direction.

The intermediate region 43e is positioned between the first region 43c and the second region 43d. The intermediate region 43e communicates with the first region 43c and the second region 43d. The intermediate region 43e has, for example, a rectangular shape as viewed in the Y-axis direction. As viewed in the Y-axis direction, a position of one end of the intermediate region 43e in the Z-axis direction coincides with a position of one end of the partition wall 432 in the Z-axis direction, and a position of the other end of the intermediate region 43e in the Z-axis direction coincides with a position of the other end of the partition wall 432 in the Z-axis direction.

The support 433 is positioned in the second region 43d. The support 433 protrudes from the bottom surface of the recess 431. A surface of the support 433 has, for example, a curved surface shape. The support 433 is a partial region of the first plate member 43.

The second plate member 44 has, for example, a rectangular plate shape. The second plate member 44 includes principal surfaces 44a and 44b and a recess 441. The principal surface 44a and the principal surface 44b face opposite sides in the Y-axis direction. The recess 441 is formed in the principal surface 44a. The recess 441 is open at one end of the second plate member 44 in the Z-axis direction. A depth of the recess 441 gradually increases from the other end side of the second plate member 44 in the Z-axis direction toward one end side of the second plate member 44 in the Z-axis direction, and then is maintained at a constant value.

The principal surface 44a of the second plate member 44 faces the principal surface 43a of the first plate member 43. As viewed in the Y-axis direction, an outer edge of the second plate member 44 coincides with an outer edge of the first plate member 43. The recess 441 of the second plate member 44 faces the first region 43c of the first plate member 43. The second plate member 44 is fixed to the first plate member 43. The second plate member 44 is bonded to, for example, the first plate member 43. The second plate member 44 is fixed to the first plate member 43 to form the first housing space S1 of the first container 4A.

The first housing space S1 is a space excluding the partition wall 432 and the support 433 in a space formed by the recess 431 and the recess 441. A width of the recess 441 in the Z-axis direction is equal to a width of the first region 43c in the Z-axis direction. A width of the recess 441 in the X-axis direction is equal to a width of the first region 43c in the X-axis direction. The opening 4a of the first container 4A is formed by an opening of the recess 441 and an opening of the first region 43c.

The second plate member 44 includes a light transmission region 4b. The light transmission region 4b is a region of the second plate member 44 overlapping the first housing space S1 as viewed in the Y-axis direction. Light generated in the first housing space S1 passes through the light transmission region 4b. In the present embodiment, the entire second plate member 44 is light-transmissive. A material of the second plate member 44 is, for example, a transparent resin or the like. In the present embodiment, the first plate member 43 also is light-transmissive. Light generated in the first housing space S1 passes through the first plate member 43. A material of the first plate member 43 is, for example, a transparent resin or the like. Note that, the first plate member 43 may not be light-transmissive.

In the embodiment, although it has been described that the subject is the human body, the subject may be, for example, an animal or the like. Although it has been described that the biological sample is the blood of the subject, the biological sample may be, for example, a body fluid or the like of the subject. The biological sample may be, for example, saliva, perfusate, tear, sweat, urine, or the like of the subject. Although it has been described that the characteristic of the biological sample is the activity of the neutrophil cell, the characteristics of the biological sample may be, for example, an activity of a tissue cell such as monocyte, eosinophil, basophil, B cell, T cell, NK cell, or vascular endothelial cell.

In the embodiment, although it has been described that the first solution 6 contains the fluorescent indicator, the first solution 6 may contain a chemiluminescent indicator. The chemiluminescent indicator reacts with a component (superoxide) generated from the biological sample. The chemiluminescent indicator is, for example, 2-Methyl-6-(4-methoxyphenyl)-3,7-dihydroimidazo[1,2-a]pyrazin-3-one (MCLA). A commercially available product may be used as the chemiluminescent indicator. In the first housing space S1 where the reaction between the superoxide generated from the biological sample and the chemiluminescence indicator of the first solution 6 is in progress, chemiluminescence having a maximum emission wavelength of about 465 nm is generated. In step S27, the chemiluminescence having the maximum emission wavelength of about 465 nm may be detected. As a result, the superoxide production activity is measured.

In the embodiment, although it has been described that the second container 7 is the pipette tip, the second container 7 may be, for example, a capillary nozzle, a dropper, a hole pipette, a Komagome pipette, a measuring pipette, a hematocrit capillary, a syringe, or the like.

In the embodiment, although it has been described that the volume of the temporary housing space S3 is equal to or larger than the volume of the second solution 8, the volume of the temporary housing space S3 may be smaller than the volume of the second solution 8.

In the embodiment, although it has been described that the second solution 8 is introduced into the second housing space S2 by the suction nozzle inserted into the opening 7b of the second container 7, the second solution 8 may be introduced into the second housing space S2 by the suction force of the second container 7 itself. Specifically, first, the opening 7b of the second container 7 is closed. Subsequently, for example, the second container 7 is pressurized from the outside of the second container 7 by the hand of an operator. As a result, the air in the second housing space S2 is led out via the opening 7a. Subsequently, the second container 7 is disposed such that the opening 7a of the second container 7 comes into contact with the second solution 8. Subsequently, the pressurization by the hand of the operator is released. As a result, the second solution 8 is sucked into the second housing space S2 via the opening 7a.

In the embodiment, although it has been described that the first solution 6 is heated by the heater 92 of the measurement device 9 in step S22, the first solution 6 may be heated by a heating device (for example, a pre-incubator or the like) provided separately from the measurement device 9 in step S22.

The biological sample measurement method may not include step S24. In this case, in step S23, the first solution 6 is heated such that the temperature of the first solution 6 is, for example, 36.8° C. to 37.2° C.

for example, the first solution 6 may contain, as an indicator reacting with hypochlorous acid (or halogen equivalent thereof) produced by myeloperoxidase, taurine/TNB (see J. Clin. Invest., Vol. 70, pp. 598-607, 1982), 8-amino-5-chloro-7-phenylpyrido[3,4-d]pyridazine-1,4-(2H,3H)dione(L-012: see Anal Biochem., Vol. 271 (1), pp. 53-58, 1999) or the like.

For example, the first solution 6 may contain, as an indicator reacting with a superoxide, 2-methyl-6-phenyl-3,7-dihydroimidazo [1,2-a]pyrazin-3-one (CLA), 2-methyl-6-p-methoxyphenylethynylimidazopyrazinone (MPEC), indocyanine-type imidazopyranodine compound (NIR-CLA), 2-[2,4,5,7-tetrafluoro-6-(2-nitro-4,5-dimethoxyphenylsulfonyloxy)-3-oxo-3H-xanthene-9-yl]benzoic acid (BES-So) or the like.

For example, the second solution 8 may contain, as a stimulant, opsonized zymon (OZ).

In the embodiment, although it has been illustrated that the first solution 6 produced in advance outside the first housing space S1 is introduced into the first housing space S1, the first solution 6 may be produced inside the first housing space S1. For example, the plurality of reagents may be introduced into the first housing space S1 in a state of being separated from each other. The plurality of reagents may be sequentially or simultaneously introduced into the first housing space S1.

In the embodiment, although it has been described that the second solution 8 contains the buffer solution, the second solution 8 may not contain the buffer solution. In this case, the deterioration of the stimulant caused by the buffer solution is suppressed. Specifically, the stimulant diluted with the buffer solution tends to deteriorate as a period until the freezing of the second solution 8 is longer. In a case where the second solution 8 does not contain the buffer solution, even though the period until freezing of the second solution 8 is relatively long, the deterioration of the stimulant is suppressed. In a case where the second solution 8 does not contain the buffer solution, the temperature of the second solution 8 may be equal to or lower than the freezing point of the organic solvent contained in the second solution 8. Note that, the buffer solution used for producing the second solution 8 may be prepared in step S12 for producing the first solution 6. Specifically, in step S12, a buffer solution corresponding to a total value of the amount of the buffer solution necessary for the production of the first solution 6 and the amount of the buffer solution necessary for the production of the second solution 8 is prepared, and the first solution 6 containing the buffer solution necessary for the production of the second solution 8 may be produced. In step $13, the first solution 6 containing the buffer solution necessary for the production of the second solution 8 may be introduced into the first housing space S1 of the first container 4. In other words, the buffer solution used for producing the second solution 8 may be introduced into the first housing space S1 in step S13. In addition, the buffer solution used for producing the second solution 8 may be added to the first housing space S1 before the addition of the second solution 8 to the first housing space S1 in step S26.

The measurement device 9 (see FIG. 9) may have an adjustment mechanism that adjusts the position of the nozzle 93 in the Z-axis direction (vertical direction). In step S26, the second solution 8 may be added to the first solution 6 in a state where the opening 7a of the second container 7 (pointed end of the second container 7) is positioned between the opening 4a of the first container 4 and the surface (liquid level) 6a of the first solution 6. A distance between the distal end of the second container 7 and the surface 6a of the first solution 6 may be, for example, about 1 mm. In this case, scattering of the second solution 8 or disturbance of the surface 6a of the first solution 6 is suppressed, and as a result, deterioration in measurement accuracy of the characteristic of the biological sample is suppressed. Specifically, in a case where the second solution 8 does not contain the buffer solution, since the addition amount of the second solution 8 tends to be very small, it is difficult to control the dropping of the second solution 8 using the nozzle 93 and the second container 7. Thus, as a result of an increase in discharge pressure of the air from the nozzle 93, the second solution 8 may be sprayed from the opening 7a of the second container 7. When the second solution 8 is sprayed from the opening 7a, the second solution 8 is scattered, and as a result, there is a concern that the stimulant added to the first solution 6 becomes insufficient. In addition, when the second solution 8 is sprayed from the opening 7a, the surface 6a of the first solution 6 is disturbed due to air bubbles, and as a result, there is a concern that scattered light is generated. The present inventors have succeeded in suppressing the deterioration in measurement accuracy of the characteristic of the biological sample due to the scattering of the second solution 8 or the disturbance of the surface 6a of the first solution 6 by optimizing the distance between the distal end of the second container 7 and the surface 6a of the first solution 6. Note that, the distance between the distal end of the second container 7 and the surface 6a of the first solution 6 may be adjusted based on the addition amount of the second solution 8, the discharge pressure of the air from the nozzle 93, or the like.

In step S17 (see FIG. 7) of the method for manufacturing the measurement unit 1, for example, PIPETMAN or the like may be used as the suction nozzle. Specifically, first, a distal end of the PIPETMAN is inserted into the opening 7b of the second container 7. Subsequently, the specified amount (for example, 0.75 μL) of the second solution 8 is sucked into the second housing space S2 of the second container 7 via the opening 7a of the second container 7 by the suction force of the PIPETMAN. Subsequently, in a state where the distal end of the PIPETMAN is inserted into the opening 7b of the second container 7, the suction amount of the PIPETMAN is increased to, for example, 3 μL. As a result, a predetermined amount of air is further sucked into the second housing space S2 through the opening 7a.

A measurement unit of the present disclosure is [1] “A measurement unit used for measuring a characteristic of a biological sample, and including a first container that includes a first housing space, a first opening communicating with the first housing space, and a light transmission region through which light generated in the first housing space is transmitted, and a first solution that is a mixture of a plurality of reagents containing an indicator reacting with a component generated from the biological sample, in which the first solution is housed in the first housing space in a state of being frozen.”.

In this measurement unit, the first solution which is the mixture of the plurality of reagents is housed in the first housing space in the state of being frozen. As a result, the measurement unit can be carried near the subject in a state where the first solution is frozen, and the biological sample collected from the subject can be added to the first solution after the first solution is defrosted near the subject. Thus, not only quality of the first solution is maintained, but also operations such as preparation of the first solution and introduction of the first solution into the first container are unnecessary near the subject. Accordingly, according to this measurement unit, the quality of the first solution is maintained, and the operation for measuring the characteristic of the biological sample is simplified.

The measurement unit of the present disclosure may be [2] “The measurement unit according to the above [1], in which the biological sample contains a white blood cell.”. A solution used for measuring the characteristic of the white blood cell may require cryopreservation. As described above, since the first solution is frozen, cryopreservation of the first solution is realized.

The measurement unit of the present disclosure may be [3] “The measurement unit according to the above [1] or [2], in which the indicator is a fluorescent indicator.”. A solution containing the fluorescent indicator may require cryopreservation. As described above, since the first solution containing the fluorescent indicator is frozen, the cryopreservation of the first solution containing the fluorescent indicator is realized.

The measurement unit of the present disclosure may be [4] “The measurement unit according to any one of the above [1] to [3] further including a rotor that is housed in the first housing space to be immersed in the first solution.”. As a result, the defrosted first solution and the biological sample added to the first housing space can be stirred by the rotor, and the dispersion of the biological sample in the first solution can be promoted.

The measurement unit of the present disclosure may be [5] “The measurement unit according to any one of the above [1] to [4], in which the first container has a flat plate shape.”. As a result, for example, as compared with a case where the first container has a columnar shape, since the specific surface area of the first container is increased, the defrosting efficiency of the first solution is improved.

The measurement unit of the present disclosure may be [6] “The measurement unit according to any one of the above [1] to [5], in which the first container includes an inner surface having a curved surface shape.”. As a result, since the liquid housed in the first housing space easily flows, the dispersion of the biological sample in the first solution is promoted.

The measurement unit of the present disclosure may be [7] “The measurement unit according to any one of the above [1] to [6] further including a second container that includes a second housing space and a second opening communicating with the second housing space, and a second solution that contains a stimulant for activating a function of the biological sample, in which the second solution is housed in the second housing space in a state of being frozen”. As a result, the measurement unit can be carried to near the subject in a state where the second solution is frozen, and after the second solution is defrosted near the subject, the defrosted second solution can be added to the first solution. Thus, not only quality of the second solution is maintained, but also an operation such as introduction of the second solution into the second container is unnecessary near the subject. Accordingly, the quality of the second solution is maintained, and the operation for measuring the characteristic of the biological sample is simplified.

The measurement unit of the present disclosure may be [8] “The measurement unit according to the above [7], in which a temporary housing space is present between the second solution and the second opening.”. As a result, even though a part of the defrosted second solution moves toward the second opening, since a part of the second solution is housed in the temporary housing space, the leakage of the second solution from the second opening is suppressed.

The measurement unit of the present disclosure may be [9] “The measurement unit according to the above [8], in which a volume of the temporary housing space is equal to or larger than a volume of the second solution.”. As a result, the leakage of the second solution from the second opening is reliably suppressed.

The measurement unit of the present disclosure may be [10] “The measurement unit according to any one of the above [7] to [9], in which the second container is a pipette tip.”. As a result, the acquisition of the second container is facilitated.

A method for manufacturing a measurement unit of the present disclosure is [11] “A method for manufacturing a measurement unit used for measuring a characteristic of a biological sample, and including a first preparation step of preparing a first container that includes a first housing space, a first opening communicating with the first housing space, and a light transmission region through which light generated in the first housing space is transmitted, and a first freezing step of freezing a first solution that is a mixture of a plurality of reagents containing an indicator reacting with a component generated from the biological sample in a state of being housed in the first housing space”.

According to the method for manufacturing the measurement unit, it is possible to manufacture the measurement unit having the above-described effect.

The method for manufacturing the measurement unit of the present disclosure may be [12] “The method for manufacturing a measurement unit according to the above [11] further including a solution production step of producing the first solution, in which in the solution production step, the plurality of reagents are mixed outside the first housing space.”. As a result, the first solution produced outside the first housing space can be sequentially introduced into the first housing spaces of the plurality of first containers, and the manufacturing efficiency of the measurement unit can be improved.

The method for manufacturing the measurement unit of the present disclosure may be [13] “The method for manufacturing a measurement unit according to the above [11] or [12], in which, in the first freezing step, the first solution is frozen in a state where a rotor housed in the first housing space is immersed in the first solution.”. As a result, it is possible to manufacture the measurement unit having the rotor immersed in the first solution.

The method for manufacturing the measurement unit of the present disclosure may be [14] “The method for manufacturing a measurement unit according to any one of the above [11] to [13] further including a second preparation step of preparing a second container that includes a second housing space and a second opening communicating with the second housing space, and a second freezing step of freezing a second solution containing a stimulant for activating a function of the biological sample in a state of being housed in the second housing space”. As a result, it is possible to manufacture the measurement unit having the above-described effect.

The method for manufacturing the measurement unit of the present disclosure may be [14] “The method for manufacturing a measurement unit according to the above [14], in which, in the second freezing step, the second solution is frozen in a state where a temporary housing space is present between the second solution and the second opening.”. As a result, even though a part of the second solution moves toward the second opening in the second freezing step, since a part of the second solution is housed in the temporary housing space, the leakage of the second solution from the second opening is suppressed.

The method for manufacturing the measurement unit of the present disclosure may be [16] “The method for manufacturing a measurement unit according to the above [15] further including a solution introduction step of introducing the second solution into the second housing space before the second freezing step, in which, in the solution introduction step, air is sucked into the second housing space via the second opening after the second solution is sucked into the second housing space via the second opening.”. As a result, the temporary housing space can be formed between the second solution and the second opening.

The method for manufacturing the measurement unit of the present disclosure may be [17] “The method for manufacturing a measurement unit according to the above [16], in which a volume of the air sucked in the solution introduction step is equal to or larger than a volume of the second solution sucked in the solution introduction step.”. As a result, the leakage of the second solution from the second opening is reliably suppressed.

A biological sample measurement method of the present disclosure is [18] “A biological sample measurement method for measuring a characteristic of a biological sample, and including a preparation step of preparing the measurement unit according to any one of the above [7] to [10], a first defrosting step of defrosting the first solution, a first adding step of adding the biological sample to the first housing space via the first opening after the first defrosting step, a second defrosting step of defrosting the second solution, a second adding step of leading out the second solution from the second opening and adding the second solution to the first housing space via the first opening after the second defrosting step, and a measurement step of measuring light generated in the first housing space and transmitted through the light transmission region of the first container”.

In this biological sample measurement method, the first solution that is the mixture of the plurality of reagents is prepared in a state of being housed and frozen in the first housing space of the first container. As a result, the measurement unit can be carried near the subject in a state where the first solution is frozen, and the biological sample collected from the subject can be added to the first solution after the first solution is defrosted near the subject. Thus, not only quality of the first solution is maintained, but also operations such as preparation of the first solution and introduction of the first solution into the first container are unnecessary near the subject. In addition, in this biological sample measurement method, the second solution is prepared in a state of being housed and frozen in the second housing space of the second container. As a result, the measurement unit can be carried to near the subject in a state where the second solution is frozen, and after the second solution is defrosted near the subject, the defrosted second solution can be added to the first solution. Thus, not only quality of the second solution is maintained, but also an operation such as introduction of the second solution into the second container is unnecessary near the subject. As described above, according to the biological sample measurement method, the qualities of the first solution and the second solution are maintained, and the operation for measuring the characteristic of the biological sample is simplified.

The biological sample measurement method of the present disclosure may be [19] “The biological sample measurement method according to the above [18] further including a temperature adjustment step of adjusting a temperature of the first solution after the first adding step, in which in the first defrosting step, the first solution is continuously heated such that the temperature of the first solution reaches an appropriate temperature for the biological sample, and in the temperature adjustment step, the first solution is heated such that the temperature of the first solution is maintained at the appropriate temperature for the biological sample”. As a result, the first solution is defrosted, and the suitable temperature environment for the biological sample is maintained.

The biological sample measurement method of the present

disclosure may be [20] “The biological sample measurement method according to the above [19], in which, in the preparation step, a rotor immersed in the first solution is prepared, and in the temperature adjustment step, the first solution is heated while the rotor is rotated”. As a result, the temperature adjustment of the first solution and dispersion of the biological sample in the first solution are promoted.

What is claimed is:

1. A measurement unit used for measuring a characteristic of a biological sample, the measurement unit comprising:
a first container that includes a first housing space, a first opening communicating with the first housing space, and a light transmission region through which light generated in the first housing space is transmitted; and
a first solution that is a mixture of a plurality of reagents containing an indicator reacting with a component generated from the biological sample, wherein
the first solution is housed in the first housing space in a state of being frozen.

2. The measurement unit according to claim 1, wherein
the biological sample contains a white blood cell.

3. The measurement unit according to claim 1, wherein
the indicator is a fluorescent indicator.

4. The measurement unit according to claim 1, further comprising:
a rotor that is housed in the first housing space to be immersed in the first solution.

5. The measurement unit according to claim 1, wherein
the first container has a flat plate shape.

6. The measurement unit according to claim 1, wherein
the first container includes an inner surface having a curved surface shape.

7. The measurement unit according to claim 1, further comprising:
a second container that includes a second housing space and a second opening communicating with the second housing space; and
a second solution that contains a stimulant for activating a function of the biological sample, wherein
the second solution is housed in the second housing space in a state of being frozen.

8. The measurement unit according to claim 7, wherein
a temporary housing space is present between the second solution and the second opening.

9. The measurement unit according to claim 8, wherein
a volume of the temporary housing space is equal to or larger than a volume of the second solution.

10. The measurement unit according to claim 7, wherein
the second container is a pipette tip.

11. A method for manufacturing a measurement unit used for measuring a characteristic of a biological sample, the method comprising:
a first preparation step of preparing a first container that includes a first housing space, a first opening communicating with the first housing space, and a light transmission region through which light generated in the first housing space is transmitted; and
a first freezing step of freezing a first solution that is a mixture of a plurality of reagents containing an indicator reacting with a component generated from the biological sample in a state of being housed in the first housing space.

12. The method for manufacturing a measurement unit according to claim 11, further comprising:
a solution production step of producing the first solution, wherein
in the solution production step, the plurality of reagents are mixed outside the first housing space.

13. The method for manufacturing a measurement unit according to claim 11, wherein
in the first freezing step, the first solution is frozen in a state where a rotor housed in the first housing space is immersed in the first solution.

14. The method for manufacturing a measurement unit according to claim 11, further comprising:
a second preparation step of preparing a second container that includes a second housing space and a second opening communicating with the second housing space; and
a second freezing step of freezing a second solution containing a stimulant for activating a function of the biological sample in a state of being housed in the second housing space.

15. The method for manufacturing a measurement unit according to claim 14, wherein
in the second freezing step, the second solution is frozen in a state where a temporary housing space is present between the second solution and the second opening.

16. The method for manufacturing a measurement unit according to claim 15, further comprising:
a solution introduction step of introducing the second solution into the second housing space before the second freezing step, wherein
in the solution introduction step, air is sucked into the second housing space via the second opening after the second solution is sucked into the second housing space via the second opening.

17. The method for manufacturing a measurement unit according to claim 16, wherein
a volume of the air sucked in the solution introduction step is equal to or larger than a volume of the second solution sucked in the solution introduction step.

18. A biological sample measurement method for measuring a characteristic of a biological sample, the method comprising:
a preparation step of preparing the measurement unit according to claim 7;
a first defrosting step of defrosting the first solution;
a first adding step of adding the biological sample to the first housing space via the first opening after the first defrosting step;
a second defrosting step of defrosting the second solution;
a second adding step of leading out the second solution from the second opening and adding the second solution to the first housing space via the first opening after the second defrosting step; and
a measurement step of measuring light generated in the first housing space and transmitted through the light transmission region of the first container.

19. The biological sample measurement method according to claim 18, further comprising:
a temperature adjustment step of adjusting a temperature of the first solution after the first adding step, wherein
in the first defrosting step, the first solution is continuously heated such that the temperature of the first solution reaches an appropriate temperature for the biological sample, and
in the temperature adjustment step, the first solution is heated such that the temperature of the first solution is maintained at the appropriate temperature for the biological sample.

20. The biological sample measurement method according to claim 19, wherein
in the preparation step, a rotor immersed in the first solution is prepared, and
in the temperature adjustment step, the first solution is heated while the rotor is rotated.
